(19) United States
(12) Patent Application Publication
(10) Pub. No.: US 2003/0084143 A1
(43) Pub. Date: May 1, 2003

(54) Resource locator management system and method

(76) Inventors: Herbert Knoesel, Cupertino, CA (US); Curt June, Eagle, ID (US); Manu N. Murthy, San Jose, CA (US); Michael D. Crocker, Sunnyvale, CA (US); Cathy Keast, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 09/999,056

(22) Filed: Oct. 31, 2001

(51) Int. Cl. G06F 15/173

(52) U.S. Cl. 709/224; 709/239

(57) ABSTRACT

System and method for managing resource locators. A database of resource locators is established for selected resource locators. For example, the resource locators are those used to reference resources maintained at multiple web sites. An automated process reads the resource locators from the database and initiates access requests for the referenced resources. For each failed access request, the failed resource locator is reported. In various embodiments, the database is configured for storage of owner identifiers and failure codes in association with the resource locators, and the resource locators are indexed in a variety of categories.

### FIELD OF THE INVENTION

The present invention generally relates to computer resource locators, and more particularly to management of a plurality of resource locators in an environment in which the resource locators are coded in files to link to the resources referenced by the locators, and the availability and locations of the resources are subject to change.

### BACKGROUND

The growth of the Internet is a result, in part, of the popularity of the hypertext transfer protocol (HTTP) and “World Wide Web” (WWW), or simply “the web.” The web uses the client-server model of computer interaction, with the server being a computer on the Internet providing information, and the client being a computer retrieving the information. The HTTP protocol permits client systems to access independent and scattered server systems. A system of uniform resource locators (URLs) is used to direct the operation of a web browser in establishing automatic transactional communication sessions with designated web server computer systems. Locations of resources on the Internet are specified with URLs. In general, each URL is of a basic form:

http://<server_name>.<sub_domain.top-level_domain>/<path>

The server_name is typically “www” and the sub_domain.top-level_domain is a standard Internet domain reference. The path is an optional additional URL qualifier.

Specification by a user of a URL on the client side results in a transaction being established in which the client sends the server an HTTP message referencing a default or explicitly-named service or data file (“web resource”) constructed in accordance with the HyperText Markup Language (HTML). This data file, web page, or hypertext document is returned in one or more response phase HTTP messages from the server to the client browser. A fully reconstructed web page image is presented by the web browser through the browser's graphical user interface.

It is common to access network resources on the Internet via hypertext links that are embedded in web pages. Hypertext links allow a user to jump from one network resource to another. A hypertext link is typically associated with a portion of a textual or graphical display, and executed by a user selecting, for example, with a mouse, the associated portion of the display. Upon selection of a hypertext link, the associated target URL address is used to address and access the associated network resource.

The URL behind a hypertext link is often hard-coded in the source web page. If the target resource is deactivated or moved (e.g., a change in storage location) without an accompanying update of the source web page, the hypertext link will be inoperable or “broken.” Broken hypertext links are often the result of a lack of communication between source and target web page providers. Providers of target web pages in many cases do not know the source web pages that link to the target web pages. Typically, broken links are discovered only after a user encounters them, and the provider of the source web page learns of broken links from users. Broken links in commercial web sites may inhibit commercial activity and lead to frustration and customer dissatisfaction.

A system and method that address the aforementioned problems, as well as other related problems, are therefore desirable.

### SUMMARY OF THE INVENTION

The invention provides a system and method for managing resource locators. In various embodiments, the invention supports coordination of valid resource locators as between, for example, different organizations that maintain the resources and organizations that make use of the resource locators to reference the resources. A database of resource locators is established for selected resource locators. For example, the resource locators are those used to reference resources maintained at multiple web sites. An automated process reads the resource locators from the database and initiates access requests for the referenced resources. For each failed access request, the failed resource locator is reported. In other embodiments, the database is configured for storage of owner identifiers and failure codes in association with the resource locators, and the resource locators are indexed in a variety of categories.

Various example embodiments are set forth in the Detailed Description and claims which follow.

### BRIEF DESCRIPTION OF THE DRAWINGS

Various aspects and advantages of the invention will become apparent upon review of the following detailed description and upon reference to the drawings in which:

FIG. 1A illustrates example relationships between web resources. Each of the resources is identified by a reference number;

FIG. 1B is a functional block diagram of a system for verifying the integrity of the locators used between various web sites, for example, the locators used in the resources of FIG. 1A; and

FIG. 2 is a flowchart of an example process for managing resource locators in accordance with one embodiment of the invention.

### DETAILED DESCRIPTION

Large companies provide a variety of web sites for servicing customer needs. For example, some companies maintain a pre-sales information support site, a shopping site, a registration site, a product support site and many other sites for servicing customers. In addition, there may be language-specific and country-specific sites to service different areas of the world. There are usually links between the web sites that support contextual navigation. For example, a customer visiting a pre-sales information web site for a particular product is provided with links to the shopping and support sites, as well as to language-specific sites relative to the same product.

Different organizations within a company are often responsible for maintaining the content of the different web sites. This provides flexibility and places decision making at the level of those most closely affected the decisions. However, the inter-organization communications by those responsible for maintaining the sites may be deficient relative to keeping the links between web sites up-to-date. For example, an organization that is responsible for maintaining a product-support web site for a particular country may decide to rehost some or all of the web site resources. In order to link to the rehosted resources, new locators must be constructed with the proper addresses. Unless this information is communicated to all the organizations that maintain the other web sites and the new locators are implemented, customers will experience errors in attempting to navigate from sites with outdated locators to the changed web site. With the vast inter-linking between web sites and the number of different organizations and people responsible for maintaining sites, ensuring operability between the sites is a constant struggle.

In various embodiments, the invention monitors the operability of resource locators that are used to reference the associated resources and records failures so that the inoperable locators can be repaired. In another embodiment, the resource locators are categorized and owners are associated therewith. When a locator is inoperable, the owner is notified of the need to update this inoperable locator in the repository.

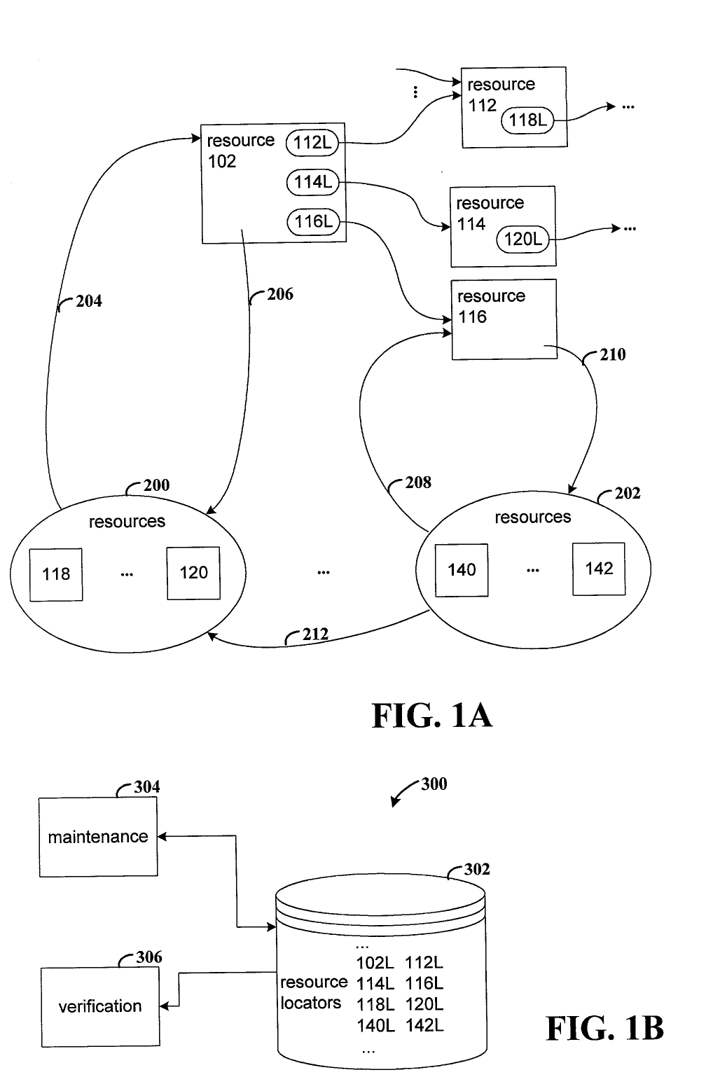

FIG. 1A illustrates example relationships between web resources. Each of the resources is identified by a reference number. The illustrated example resources include resources 102, 112, 114, 116, 118, 120, 140, and 142. The resources represent either data files or services that are available at a web site. Ellipses 200 and 202 represent sets of resources comprise respective web sites. For example, the resources 202 may be part of a shopping site, and resources 202 may be part of a product support site.

Within example resources 102, 112, 114, and 116, various example locators are illustrated. In one embodiment, the locators are URLs. However, those skilled in the art will recognize alternative resource-reference schemes that are within the teachings of the present invention. Resource 102 includes locators 112L, 114L, and 116L, which respectively reference the resources 112, 114, and 116. Resources 112 and 114 include locators 118L and 120L, respectively. Resource locators 118L and 120L reference resources 118 and 120 in set 200. Lines 204, 206, 208, 210, and 212 represent other assorted links between resources.

FIG. 1B is a functional block diagram of a system for verifying the integrity of the locators used between various web sites, for example, the locators used in the resources of FIG. 1A. System 300 includes a resource locator database 302, a maintenance module 304, and a verification module 306. In one embodiment, database 302 stores the resource locators that are to be verified. For example, the resource locators corresponding to the example environment of FIG. 1A include 102L, 112L, 114L, 116L, 118L, 120L, 140L, and 142L.

The resource locators are loaded into database 302 via maintenance module 304. For example, maintenance module 304 reads the locators from text files that are provided by the organizations that maintain the various web sites. The maintenance module also includes a user interface for manually entering and updating locators stored in the database.

In another embodiment, resource locator database 302 categorizes the resource locators and indexes the database using selected indices. In an example embodiment the locators are indexed by type of web site (pre-sales, support, shopping, etc.), product identifier (product number, product series, product family, etc.), country, and language. Those skilled in the art will recognize other index categories for different applications.

Additional descriptive information is stored in association with the locators in the example embodiment. The additional information includes a textual description of an associated product (in the appropriate language), a status, and an owner identifier. The owner identifier is used to notify the owner when the locator is inoperable.

Because there may be some variation in data that is returned in response to issuing a request addressed to an out-of-date locator, the database 302 also includes failure criteria that are associated with the locators. For example, in one embodiment the failure criteria includes a set of character strings, the occurrence of any one of which indicates an inoperable locator. This feature allows users to tailor the verification process to meet failure criteria that may change over time.

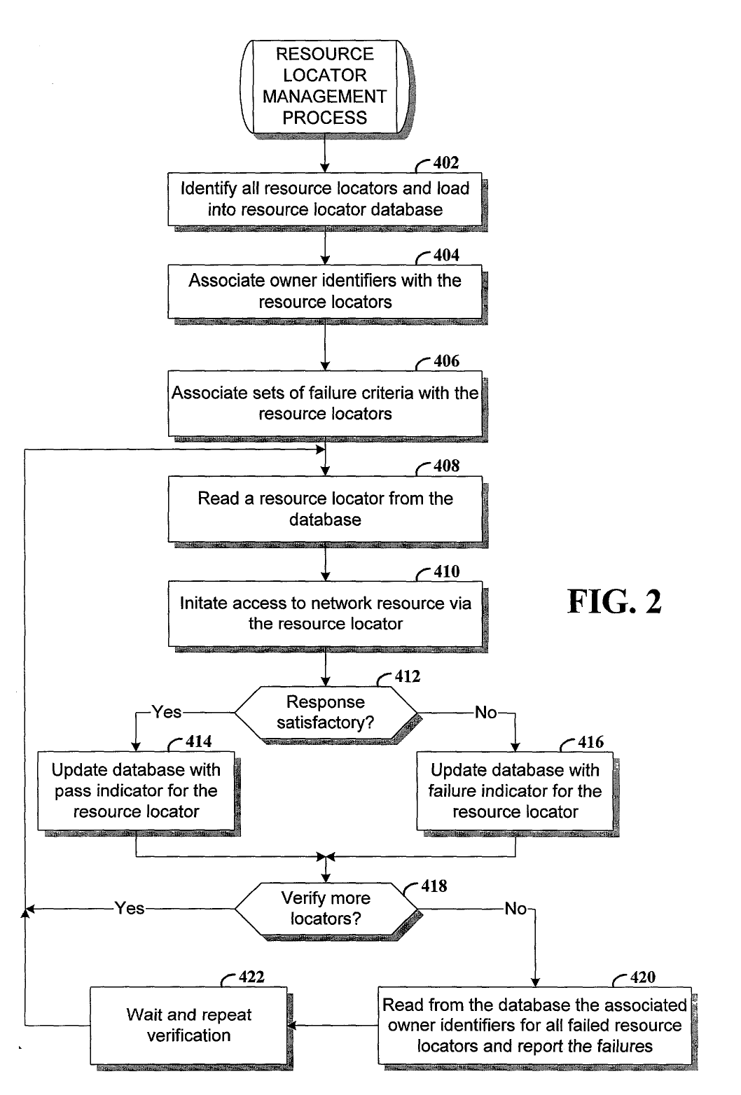

FIG. 2 is a flowchart of an example process for managing resource locators in accordance with one embodiment of the invention. At steps 402, 404, and 406, the resource locator database is populated. The steps entail identifying the resource locators that are to be managed and verified and associating owner identifiers and failure criteria with the locators. In addition, the resource locators are categorized by the indices discussed above. In an example embodiment, the update of the database is an on-going process, for example because of new product introductions and product obsolescence. Typically all web section owners that provide resource locators for the repository periodically supply text files with the appropriate information needed to update resource locators in referencing pages.

After the locator database is established, an automated process is started to verify the validity of the locators. The frequency with which the locators are verified depends on frequency with which the resources that use the locators are changed. In one embodiment, the verification module (306, FIG. 1B) is a background process that runs daily.

At step 408, a resource locator is read from the database, and step 410 initiates access to the resource referenced by the resource locator. If the response is satisfactory, decision step 412 directs the process to step 414. Otherwise, the process is directed to step 416. If the response received in response to the access request does not meet any of the associated failure criteria, or alternatively, the response does not meet some predefined, preprogrammed failure criteria, the database is updated with a pass indicator for the resource locator. Otherwise, a failure indicator is associated with the resource locator.

Decision step 418 tests whether there are any additional locators to verify. If so, the process is returned to step 408. Otherwise, the process is directed to step 420 where the owners of the failed resource locators are identified. Recall that each resource locator has an associated owner identifier. The failed locators are reported to the owners, for example, by email. In another embodiment, the failed locators are reported to a database administrator in an electronic document.

The process then continues at step 422, where the verification process waits for a programmed period of time before repeating the verification beginning at step 408.

An organization that maintains web pages that reference resources that are controlled by another organization must establish a procedure to ensure that the resource locators used in its web pages are operable. Database 302 can be used for this purpose. For example, an organization periodically queries database 302 for all resource locators that are pertinent to its web pages. Example selection criteria include, for example, the type of web site (pre-sales, product support, shopping, etc.), product identifier (product number, product series, product family, etc.), country, and language. The valid resource locators are those having the associated pass indicator. The resource locators returned in response to the query can then be cross-checked against the resource locators used in the organization's web pages. The timing and frequency of this process depends on the procedure used by the organization to build and maintain its web site.

In addition to the example embodiments described above, other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A computer-implemented method for managing resource locators that are used to reference resources hosted by one or more computing nodes on a network, comprising:
establishing a database of selected resource locators;
reading the resource locators from the database;
initiating access requests for the resources referenced by the resource locators read from the database; and
for each failed access request, reporting the resource locator from which the failed access request was initiated, wherein a failed access request is an access request that results in a response that satisfies selected failure criteria.

2. The method of claim 1, further comprising for each failed access request, generating an electronic message and sending the message to a selected recipient.

3. The method of claim 2, further comprising:
configuring the database with respective owner addresses associated with the resource locators; and
sending the electronic message to the owner address associated with the resource locator from which the failed access request was initiated.

4. The method of claim 3, wherein the owner addresses are email addresses.

5. The method of claim 1, further comprising periodically repeating the steps of reading resource locators, initiating access requests, and reporting failed access requests.

6. The method of claim 1, further comprising for resource-response messages that result from the access requests, identifying resource-response messages that satisfy selected failure criteria.

7. The method of claim 6, further comprising associating in the database respective sets of failure criteria with the resource locators.

8. The method of claim 7, wherein each set of failure criteria includes textual data, and further comprising searching for the textual data in a resource-response message.

9. The method of claim 1, further comprising indexing the resource locators in the database with an selected index code.

10. The method of claim 1, further comprising indexing the resource locators in the database with a plurality of index codes.

11. The method of claim 10, wherein the index codes include a plurality of product identifiers.

12. The method of claim 10, wherein the index codes include a plurality of country identifiers.

13. The method of claim 10, wherein the index codes include a plurality of language identifiers.

14. The method of claim 10, wherein the index codes include a plurality of web site categories.

15. The method of claim 1, further comprising associating a failure code with each resource locator resulting in a failed access request.

16. An apparatus for managing resource locators that are used to reference resources hosted by one or more computing nodes on a network, comprising:
means for establishing a database of selected resource locators;
means for reading the resource locators from the database;
means for initiating access requests for the resources referenced by the resource locators read from the database; and
means, responsive to each failed access request, for reporting the resource locator from which the failed access request was initiated, wherein a failed access request is an access request that results in a response that satisfies selected failure criteria.

17. A system for managing resource locators that are used to reference resources hosted by one or more computing nodes on a network, comprising:
a database configured for indexed storage of selected resource locators; and
a verification module configured to read the resource locators from the database, initiate access requests for the network resources referenced by the resource locators read from the database, and for each failed access request, report the resource locator from which the failed access request was initiated, wherein a failed access request is an access request that results in a response that satisfies selected failure criteria.

18. The system of claim 17, further comprising:
wherein the database is configured for storage of owner-email addresses in association with the resource locators; and
the verification module is configured to send an electronic message to the owner-email address associated with the resource locator from which the failed access request was initiated.

19. The system of claim 17, wherein the database is configured for storage of respective sets of failure criteria in association with the resource locators.

20. The system of claim 17, wherein resource locators are indexed by a plurality of product identifiers.

21. The system of claim 17, wherein resource locators are indexed by a plurality of country identifiers.

22. The system of claim 17, wherein resource locators are indexed by a plurality of language identifiers.

23. The system of claim 17, wherein resource locators are indexed by a plurality of web site categories.

24. The system of claim 17, wherein the database is configured for storage of a failure code in association with each resource locator resulting in a failed access request, and the verification module is configured to store a failure code in association with each resource locator resulting in a failed access request.
